(19) United States
(12) Patent Application Publication
(10) Pub. No.: US 2026/0001630 A1
(43) Pub. Date: Jan. 1, 2026

(54) BUOYANT PONTOON STRUCTURE

(71) Applicant: 3PO Boat Accessories, LLC, Duchesne, UT (US)

(72) Inventor: Guy Taylor, JR., Duchesne, UT (US)

(21) Appl. No.: 18/761,121

(22) Filed: Jul. 1, 2024

(51) Int. Cl. B63B 35/34; B63B 1/04

(52) U.S. Cl. CPC B63B 35/34; B63B 1/042

(57) ABSTRACT

A buoyant pontoon includes a plumb bow having a leading edge, first and second bow surfaces extending from the leading edge and joining corresponding first and second lateral surfaces, a bottom surface joining the bow surfaces and the lateral surfaces, a stern surface extending upwardly from the bottom surface, and a top surface. The bottom surface has a transverse cross-sectional profile shape including a first outer V-shaped feature, a center V-shaped feature, and a second outer V-shaped feature. The center V-shaped feature extends a vertical distance lower than the first and second outer V-shaped features. The first bow surface and the bottom surface define an opening to a first vent located between the first outer V-shaped feature and the center V-shaped feature. The second bow surface and the bottom surface define an opening to a second vent located between the second outer V-shaped feature and the center V-shaped feature.

### BACKGROUND OF THE INVENTION

The disclosure relates a buoyant pontoon structure for use with watercraft. The disclosed pontoon structure provides improved hydrodynamic performance compared to conventional cylindrical-shaped pontoons.

Pontoon boats use pairs of buoyant pontoons as flotation devices to support the deck. Pontoon boats are a popular recreational watercraft. Pontoon boats are known to be stable and safe watercraft. The deck of a pontoon boat is typically large enough to accommodate several people simultaneously during travel of the pontoon boat across a body of water. They have good load carrying capacity and roominess.

Buoyant pontoons used to support a pontoon boat deck are typically in the form of elongated cylindrical hollow enclosures. They are often formed from a thin sheet metal material, such as aluminum. Sometimes a foamed material is inserted within the buoyant pontoon to provide increased structural integrity and a degree of flotation in the event the hollow enclosure is punctured.

Although stable, pontoon boats using cylindrical-shaped pontoon structures typically have somewhat limited handling and performance characteristics compared to other watercraft, such as V-hulled boats. This limited performance may become especially noticeable at higher speeds or in rough water. Thus, pontoon boats historically travel at low rates, compared to other types of watercraft, such as ski boats or boats with planing hulls. Consequently, it is desirable to provide a buoyant pontoon for use in a watercraft which provides improved hydrodynamic performance.

### BRIEF SUMMARY OF THE INVENTION

The disclosed invention relates generally to a buoyant pontoon for use with watercraft. The pontoon is an elongated structure comprising a bottom surface, lateral surfaces joined to outer edges of the bottom surface, a plumb bow having a leading edge with bow surfaces extending from the leading edge to the lateral surfaces and lower edges of the bow surfaces joining the bottom surface, a stern surface joined to trailing edges of the lateral surfaces and to the bottom surface, and an upper surface joined to upper edges of the lateral surfaces, to upper edges of the bow surfaces, and to an upper edge of the stern surface.

In an embodiment, the bottom surface has a transverse cross-sectional profile shape comprising a first outer V-shaped feature, a center V-shaped feature, and a second outer V-shaped feature, wherein the center V-shaped feature extends a vertical distance lower than the first and second outer V-shaped features.

In an embodiment, the lateral surfaces comprise a first lateral surface joined to an outer edge of the first outer V-shaped feature and a second lateral surface joined to an outer edge of the second outer V-shaped feature, wherein the first and second lateral surfaces extend upwardly from the bottom surface.

In an embodiment, the bow surfaces comprise a first bow surface extending from the leading edge to the first lateral surface and a second bow surface extending from the leading edge to the second lateral surface.

In an embodiment, the first bow surface joins the bottom surface and defines an opening to a first vent located between the first outer V-shaped feature and the center V-shaped feature and the second bow surface joins the bottom surface and defines an opening to a second vent located between the second outer V-shaped feature and the center V-shaped feature.

In an embodiment, the buoyant pontoon includes an upper surface and a stern surface. The upper surface is joined to the plumb bow, the first and second bow surfaces, the first and second lateral surfaces, and to the stern surface. The stern surface is further joined to the first and second lateral surfaces and to the bottom surface.

In an embodiment, all of the surfaces of the buoyant pontoon are joined at adjoining edges to form an elongate, enclosed, watertight structure. In an embodiment, some of the adjoining surfaces are joined or formed via bending or folding of sheet metal material from which the buoyant pontoon is constructed. In an embodiment, some of the adjoining surfaces are joined via welding along adjacent edges.

In an embodiment, the first outer V-shaped feature is joined to the center V-shaped feature and the center V-shaped feature is joined to the second outer V-shaped feature.

In an embodiment, the first outer V-shaped feature and the second outer V-shaped feature have asymmetric transverse cross-sectional profile shapes.

In an embodiment, the center V-shaped feature has a symmetric transverse cross-sectional profile shape.

In an embodiment, the leading edge is substantially vertical. As used herein, “substantially vertical” means that the leading edge extends vertically from a horizontal line at an angle between 85° and 100°. In other words, the leading edge extends vertically from a horizontal line at an angle of about 85°, 86°, 87°, 88°, 89°, 90°, 91°, 92°, 93°, 94°, 95°, 96°, 97°, 98°, 99°, or 100°, where any of the stated values can form an upper or lower endpoint of a range. In an embodiment, the first bow surface is substantially vertical. In an embodiment, the second bow surface is substantially vertical.

In an embodiment, the first bow surface is substantially planar. In an embodiment, the second bow surface is substantially planar. As used herein, “substantially planar” means that the surface is flat or level in all directions, with only minor deviation from flat present on the surface. A deviation from flat is defined as the distance V measured between a point on a reference plane and the corresponding point on the actual plane. For a line having a distance X drawn through the point extending from one edge of the surface to the opposite edge of the surface, a deviation from flat is considered to be a minor deviation from flat when the ratio V/X is less than or equal to 0.1.

In an embodiment, the first outer V-shaped feature has a transverse cross-section profile shape defined by a first outer side and a first inner side joined at a first low vertex, the second outer V-shaped feature has a transverse cross-section profile shape defined by a second outer side and a second inner side joined at a second low vertex, the center V-shaped feature has a transverse cross-section profile shape defined by a first center side and a second center side joined at a center low vertex.

In an embodiment, the first vent has a transverse cross-section profile shape defined by the first inner side and the first center side joined at a first vent vertex and the second vent has a transverse cross-section profile shape defined by the second inner side and the second center side joined at a second vent vertex.

In an embodiment, the first vent and the second vent have asymmetric transverse cross-sectional profile shapes.

In an embodiment, the first vent comprises a first outer vent distance d1_{OV} defined by a vertical distance between the first low vertex and the first vent vertex and a first inner vent distance d1_{IV} defined by a vertical distance between the center low vertex and the first low vertex wherein the distance d1_{OV} is between about 40% and 90% of the distance d1_{IV}.

In an embodiment, the second vent comprises a second outer vent distance d2_{OV} defined by a vertical distance between the second low vertex and the second vent vertex and a second inner vent distance d2_{IV} defined by a vertical distance between the center low vertex and the second low vertex, wherein the distance d2_{OV} is between about 40% and 90% of the distance d2_{IV}.

In an embodiment, the first outer V-shaped feature comprises a distance d1_{OE} defined by a vertical distance between the outer edge of the first outer V-shaped feature and the first low vertex and a center V-shaped feature comprises a distance d1_{CV} defined by a vertical distance between the outer edge of the first outer V-shaped feature and the center low vertex, wherein the distance d1_{OE} is between 40% and 90% of the distance d1_{CV}.

In an embodiment, the pontoon has a width w, and wherein the wherein the center V-shaped feature extends a vertical distance d lower than the first and second outer V-shaped features and the distance d is from about 0.5% to about 5% of the width w.

In an embodiment, the first vent has a transverse cross-section profile shape in the form of an inverted V.

In an embodiment, the second vent has a transverse cross-section profile shape in the form of an inverted V.

The disclosed invention includes a pontoon boat comprising a pair of buoyant pontoons.

As used herein, the term V-shape or inverted V-shape means a transverse cross-section profile shape having or resembling the general shape of the letter V (∨) or an inverted letter V (∧).

The above and other objects and advantages of the present invention are realized in illustrated embodiments thereof, shown and described by way of example and not by way of limitation, and the following detailed description of the invention and the drawings, in which similar structure is identified with similar numbers throughout.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 is a front and top perspective view of a buoyant pontoon for use with watercraft;

FIG. 2 is a front and bottom perspective view of the buoyant pontoon;

FIGS. 3 and 4 are side views of the buoyant pontoon; and

FIGS. 5A-5D are front views of the buoyant pontoon showing the cross-sectional profile of the bottom surface.

### DETAILED DESCRIPTION OF THE INVENTION

The disclosed invention relates generally to a buoyant pontoon for use with watercraft.

The embodiments of the present disclosure will be best understood by reference to the drawings, wherein like parts are designated by like numerals throughout. It will be readily understood that the components of the present disclosure, as generally described and illustrated in the Figures herein, could be arranged and designed in a wide variety of different configurations. Thus, the following more detailed description of the embodiments is not intended to limit the scope of the invention, as claimed, but is merely representative of some embodiments of the invention.

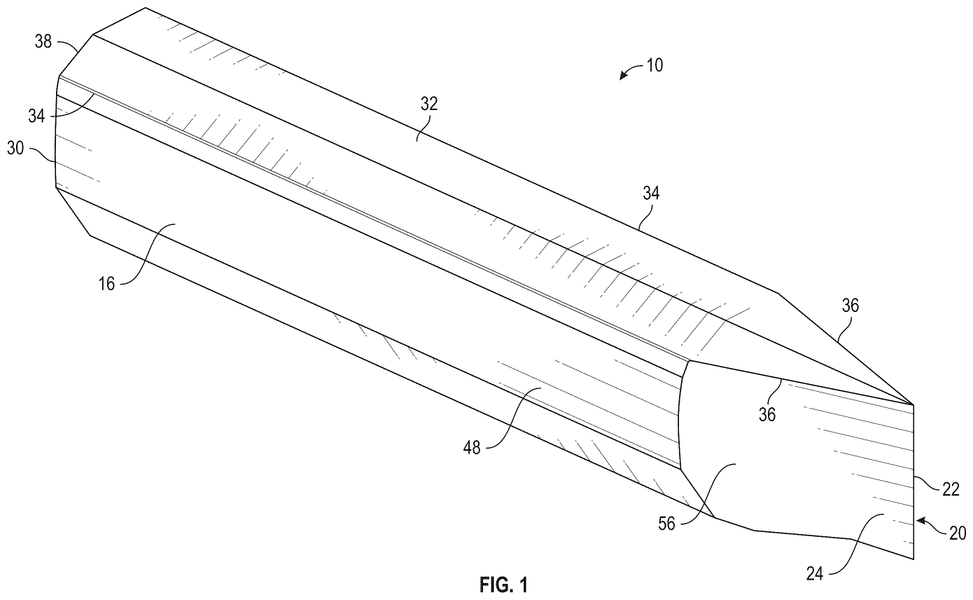

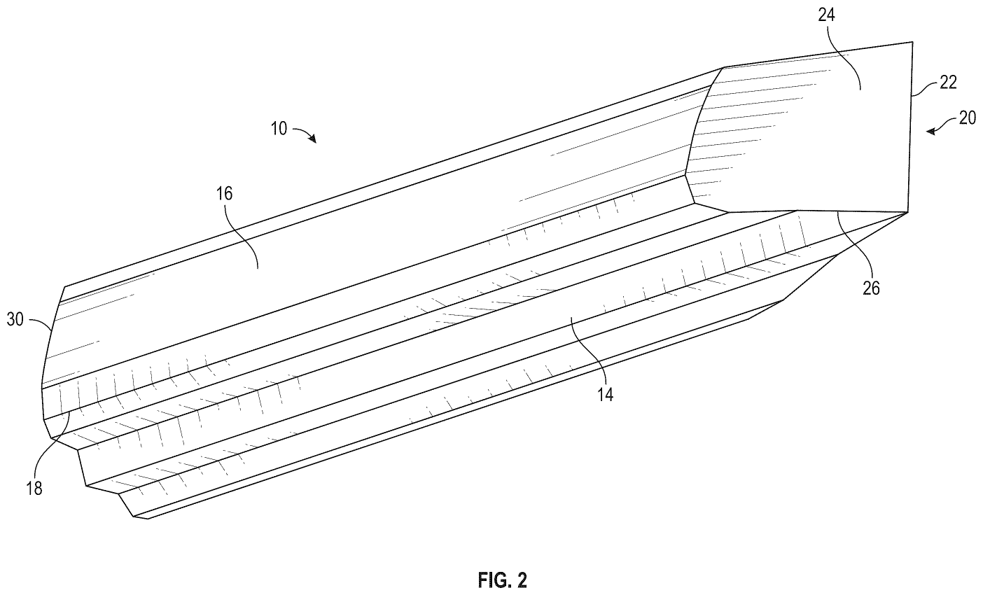

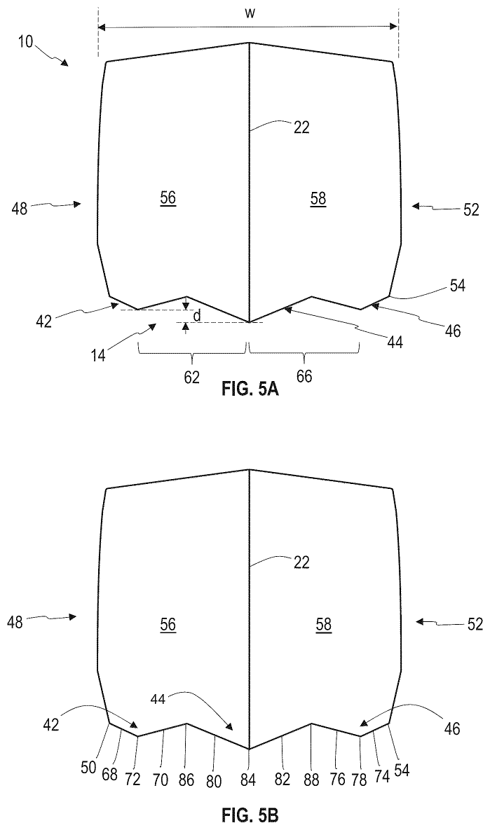

Referring to FIGS. 1-4 the buoyant pontoon 10 is an elongated structure comprising a bottom surface 14, lateral surfaces 16 joined to outer edges 18 of the bottom surface, a plumb bow 20 having a leading edge 22 with bow surfaces 24 extending from the leading edge 22 to the lateral surfaces 16 and lower edges 26 of the bow surfaces joining the bottom surface 14, a stern surface 28 joined to trailing edges 30 of the lateral surfaces 16 and to the bottom surface, and an upper surface 32 joined to upper edges 34 of the lateral surfaces 16, to upper edges 36 of the bow surfaces 24, and to an upper edge 38 of the stern surface 28.

In an embodiment, the buoyant pontoon includes an upper surface 32 and a stern surface 28. The upper surface 32 is joined to the plumb bow 20, to the bow surfaces 24, to the lateral surfaces 16, and to the stern surface 28. The stern surface 28 is further joined to the lateral surfaces 16 and to the bottom surface 14.

In an embodiment, all of the surfaces of the buoyant pontoon are joined at adjoining edges to form an elongate, enclosed, watertight structure. In an embodiment, some of the adjoining surfaces are joined or formed via bending or folding of sheet metal material from which the buoyant pontoon is constructed. In an embodiment, some of the adjoining surfaces are joined via welding along adjacent edges. In an embodiment, some of the surfaces are joined via adhesive applied to overlapping surface portions.

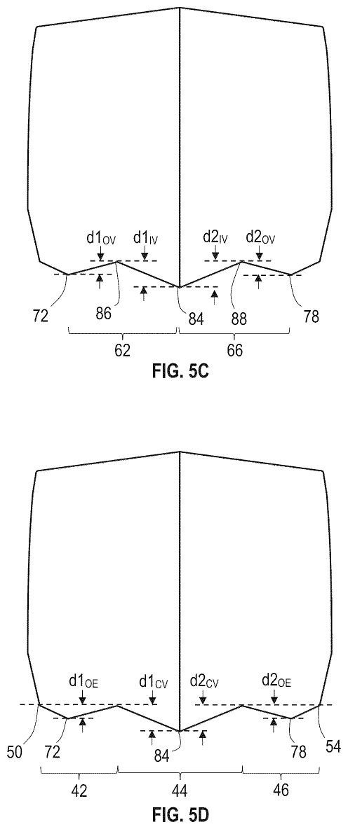

Referring to FIGS. 5A through 5D, which are front views or bow views of the buoyant pontoon 10. As shown in FIG. 5A, in an embodiment the bottom surface 14 has a transverse cross-sectional profile shape comprising a first outer V-shaped feature 42, a center V-shaped feature 44, and a second outer V-shaped feature 46, wherein the center V-shaped feature 44 extends a vertical distance d lower than the first and second outer V-shaped features 42, 46.

In an embodiment, the buoyant pontoon 10 has a width w, and wherein the wherein the center V-shaped feature extends a vertical distance d lower than the first and second outer V-shaped features and the distance d is from about 0.5% to about 5% of the width w.

In an embodiment, the lateral surfaces 16 comprise a first lateral surface 48 joined to an outer edge 50 of the first outer V-shaped feature 42 and a second lateral surface 52 joined to an outer edge 54 of the second outer V-shaped feature, wherein the first and second lateral surfaces 48, 52 extend upwardly from the bottom surface 14.

In an embodiment, the bow surfaces 24 comprise a first bow surface 56 extending from the leading edge 22 to the first lateral surface 48 and a second bow surface 58 extending from the leading edge 22 to the second lateral surface 52.

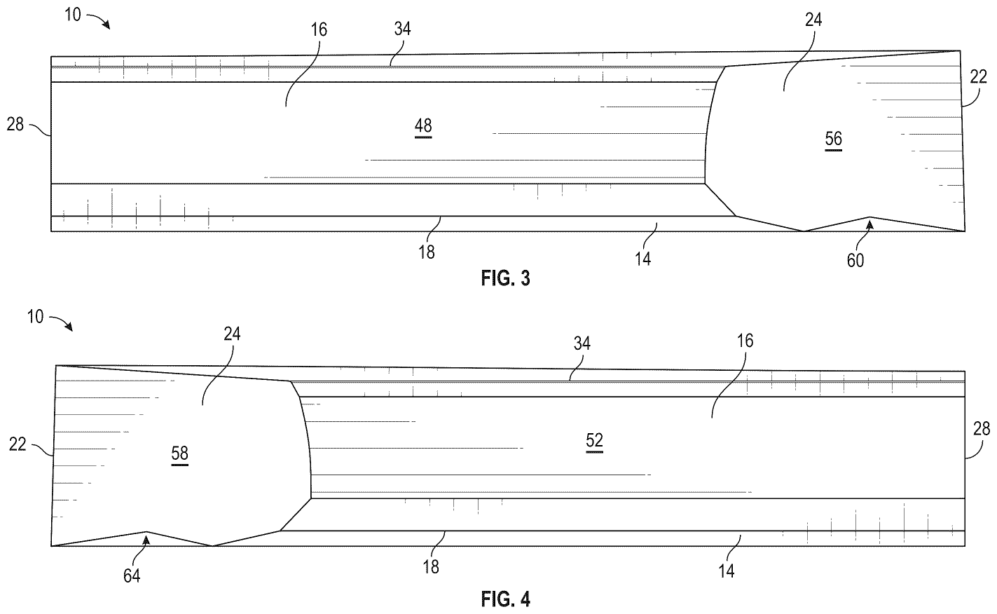

As shown in FIGS. 3, 4, and 5A, in an embodiment, the first bow surface 56 joins the bottom surface 14 and defines an opening 60 to a first vent 62 located between the first outer V-shaped feature 42 and the center V-shaped feature 44 and the second bow surface 58 joins the bottom surface 14 and defines an opening 64 to a second vent 66 located between the second outer V-shaped feature 46 and the center V-shaped feature 44.

In an embodiment, the first outer V-shaped feature 42 is joined to the center V-shaped feature 44 and the center V-shaped feature 44 is joined to the second outer V-shaped feature 46.

In an embodiment, the first outer V-shaped feature 42 and the second outer V-shaped feature 46 have asymmetric transverse cross-sectional profile shapes.

In an embodiment, the center V-shaped feature 44 has a symmetric transverse cross-sectional profile shape.

In some embodiments, the leading edge 22 is substantially vertical. As used herein, “substantially vertical” means that the leading edge extends vertically from a horizontal line at an angle between 85° and 100°. In an embodiment, the first bow surface 56 is substantially vertical. In an embodiment, the second bow surface 58 is substantially vertical.

In an embodiment, the first bow surface 56 is substantially planar. In an embodiment, the second bow surface 58 is substantially planar. As used herein, “substantially planar” means that the surface is flat or level in all directions, with only minor deviation from flat present on the surface. A deviation from flat is defined as the distance V measured between a point on a reference plane and the corresponding point on the actual plane. For a line having a distance X drawn through the point extending from one edge of the surface to the opposite edge of the surface, a deviation from flat is considered to be a minor deviation from flat when the ratio V/X is less than or equal to 0.1.

Referring to FIG. 5B, in an embodiment, the first outer V-shaped feature 42 has a transverse cross-section profile shape defined by a first outer side 68 and a first inner side 70 joined at a first low vertex 72, the second outer V-shaped feature 46 has a transverse cross-section profile shape defined by a second outer side 74 and a second inner side 76 joined at a second low vertex 78, the center V-shaped feature has a transverse cross-section profile shape defined by a first center side 80 and a second center side 82 joined at a center low vertex 83.

In an embodiment, the first vent 62 has a transverse cross-section profile shape defined by the first inner side 70 and the first center side 80 joined at a first vent vertex 86 and the second vent 66 has a transverse cross-section profile shape defined by the second inner side 76 and the second center side 82 joined at a second vent vertex 88.

In an embodiment, the first vent 62 and the second vent 66 have asymmetric transverse cross-sectional profile shapes.

Referring to FIG. 5C, in an embodiment, the first vent 62 comprises a first outer vent distance d1_{OV} defined by a vertical distance between the first low vertex 72 and the first vent vertex 86 and a first inner vent distance d1_{IV} defined by a vertical distance between the center low vertex 84 and the first low vertex 72 wherein the distance d1_{OV} is between about 40% and 90% of the distance d1_{IV}.

In an embodiment, the second vent 66 comprises a second outer vent distance d2_{OV} defined by a vertical distance between the second low vertex 78 and the second vent vertex 88 and a second inner vent distance d2_{IV} defined by a vertical distance between the center low vertex 84 and the second low vertex 78, wherein the distance d2_{OV} is between about 40% and 90% of the distance d2_{IV}.

Referring to FIG. 5D, in an embodiment, the first outer V-shaped feature 42 comprises a distance d1_{OE} defined by a vertical distance between the outer edge 50 of the first outer V-shaped feature 42 and the first low vertex 72 and a center V-shaped feature 44 comprises a distance d1_{CV} defined by a vertical distance between the outer edge 50 of the first outer V-shaped feature 42 and the center low vertex 84, wherein the distance d1_{OE} is between 40% and 90% of the distance d1_{CV}.

In an embodiment, the second outer V-shaped feature 46 comprises a distance d2_{OE} defined by a vertical distance between the outer edge 54 of the second outer V-shaped feature 46 and the second low vertex 78 and a center V-shaped feature 44 comprises a distance d2_{CV} defined by a vertical distance between the outer edge 54 of the second outer V-shaped feature 46 and the center low vertex 84, wherein the distance d2_{OE} is between 40% and 90% of the distance d2_{CV}.

In an embodiment, the first vent 62 has a transverse cross-section profile shape in the form of an inverted V.

In an embodiment, the second vent 66 has a transverse cross-section profile shape in the form of an inverted V.

The disclosed invention includes a pontoon boat comprising a pair of buoyant pontoons.

The performance of the buoyant pontoon disclosed herein was compared to a commercially available pontoon manufactured by Monark Boat Company, Model SL 160 B. The OEM pontoon included a cylindrical pontoon body with a nose portion shaped to minimize the resistance to forward movement of the pontoon through the water.

### Example 1

The drag force exerted by flowing water against the OEM pontoon and the disclosed buoyant pontoon was measured in a canal with water flowing at a rate between about 3 and 4 miles per hour. A strap was connected to the front of each respective pontoon structure and a gauge was connected to the strap to measure the drag force exerted by the OEM pontoon and by the disclosed buoyant pontoon. The drag force exerted by the disclosed buoyant pontoon was measured to be about 4 pounds. The drag force exerted by the OEM pontoon was measured to be about 13 pounds.

### Example 2

The performance of a pontoon boat equipped with a pair of OEM pontoons was compared with the performance of the same pontoon boat equipped with a pair of buoyant pontoons disclosed herein. The pontoon boat was manufactured by Monark Boat Company, Model SL 160 B. The pontoon boat was equipped with electric propulsion motors and all testing was done with the electric motors. Speed was measured using GPS. All conditions were as consistent as possible, including outside temperature, wind, boat loading, and the use of fully charged batteries.

The pontoon boat equipped with the pair of OEM pontoons operated at a maximum speed of 3.4 miles per hour. The OEM pontoons were replaced with a pair of buoyant pontoons disclosed herein. The pontoon boat equipped with the disclosed buoyant pontoons operated at a maximum speed ranging from 4.4 to 4.5 miles per hour. This represented an improvement of approximately 30%

Without being bound by theory, it is presently believed that the original OEM pontoon bow design cuts through the water and the displaced water travels around the length of the bow; then down the side of the hull.

In contrast, the bow configuration of the disclosed buoyant pontoon includes a plumb bow 20 having a leading edge 22 with bow surfaces 24 extending from the leading edge 22 to the lateral surfaces 16 and lower edges 26 of the bow surfaces joining the bottom surface 14. In an embodiment, the leading edge is substantially vertical, and the bow surfaces are substantially vertical. Because the bottom surface 14 has a transverse cross-sectional profile shape comprising a first outer V-shaped feature 42, a center V-shaped feature 44, and a second outer V-shaped feature 46, as the bow surfaces 24 join to the bottom surface 14 the lower edges 26 of the bow surfaces are not linear, but rather rise vertically as they extend from the leading edge to form the openings 60, 64 to the first and second vents 62, 66. The lower edges 26 then descend vertically as they extend from the vent openings to the lateral surfaces. This configuration bow structure is referred to herein as a beak bow.

With the disclosed beak bow, the leading edge of the bow cuts through the water, but the water is soon redirected under the pontoon to the first and second vents, adding lift and reducing form drag. The reduced drag results in a more efficient design.

As noted, the disclosed beak bow has vertical up and down lower edges that cut through waves and give the buoyant pontoon better performance in chop or wakes.

The sharp leading edge in conjunction with the beak bow shape are designed to work in conjunction with each other to push water under the pontoon thus creating lift; forcing water downward and the pontoon up, breaking up surface tension of the water providing lift resulting in greater speed.

In summary, it is believed the combination of the beak bow with its sharp leading edge and the vents at the rear of the bow allow the displaced water to make a smooth transition under the pontoon, thereby allowing a controlled smooth transfer and efficient use of the moving water. The result of this new pontoon configuration is reduced form drag compared to conventional cylindrical pontoon configurations. The new pontoon structure disclosed herein may provide enhanced direction, added lift, stability, maneuverability, and speed utilizing the same input of power.

As used herein, unless explicitly stated otherwise or clearly implied otherwise, the term “about” refers to a range of values plus or minus 10 percent (“±10%”), e.g., about 1.0 encompasses values from 0.9 to 1.1.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to 5” should be interpreted to include not only the explicitly recited values of about 1 to 5, but also include the individual values and sub-ranges within the indicated range. Thus, included in this numerical range are individual values such as 2, 3, and 4 and sub-ranges such as from 1-3, from 2-4, and from 3-5, etc. This same principle applies to ranges reciting only one numerical value. Furthermore, such an interpretation should apply regardless of the range or the characteristics being described.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner and in one or more embodiments. In the foregoing description, numerous specific details are provided, such as examples of buoyant pontoon structures to provide a thorough understanding of embodiments of the invention. One skilled in the relevant art will recognize, however, that the invention may be practiced without one or more of the specific details or methods, or with other methods, components, characteristics, materials, and so forth. In other instances, well-known structures, materials, or operations are not shown or described in detail to avoid obscuring aspects of the invention.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

1. A buoyant pontoon comprising:
a bottom surface having a transverse cross-sectional profile shape comprising a first outer V-shaped feature, a center V-shaped feature, and a second outer V-shaped feature, wherein the center V-shaped feature extends a vertical distance lower than the first and second outer V-shaped features;
a first lateral surface joined to an outer edge of the first outer V-shaped feature and a second lateral surface joined to an outer edge of the second outer V-shaped feature, wherein the first and second lateral surfaces extend upwardly from the bottom surface;
a plumb bow having a leading edge; and
a first bow surface extending from the leading edge to the first lateral surface and a second bow surface extending from the leading edge to the second lateral surface;
wherein the first bow surface joins the bottom surface and defines an opening to a first vent located between the first outer V-shaped feature and the center V-shaped feature and the second bow surface joins the bottom surface and defines an opening to a second vent located between the second outer V-shaped feature and the center V-shaped feature.

2. The buoyant pontoon of claim 1, wherein the first outer V-shaped feature is joined to the center V-shaped feature and the center V-shaped feature is joined to the second outer V-shaped feature.

3. The buoyant pontoon of claim 1, wherein the first outer V-shaped feature and the second outer V-shaped feature have asymmetric transverse cross-sectional profile shapes.

4. The buoyant pontoon of claim 1, wherein the center V-shaped feature has a symmetric transverse cross-sectional profile shape.

5. The buoyant pontoon of claim 1, wherein the leading edge is substantially vertical.

6. The buoyant pontoon of claim 1, wherein the first bow surface is substantially vertical.

7. The buoyant pontoon of claim 1, wherein the second bow surface is substantially vertical.

8. The buoyant pontoon of claim 1, wherein the first bow surface is substantially planar.

9. The buoyant pontoon of claim 1, wherein the second bow surface is substantially planar.

10. The buoyant pontoon of claim 1, wherein the first outer V-shaped feature has a transverse cross-section profile shape defined by a first outer side and a first inner side joined at a first low vertex, the second outer V-shaped feature has a transverse cross-section profile shape defined by a second outer side and a second inner side joined at a second low vertex, the center V-shaped feature has a transverse cross-section profile shape defined by a first center side and a second center side joined at a center low vertex.

11. The buoyant pontoon of claim 10, wherein the first vent has a transverse cross-section profile shape defined by the first inner side and the first center side joined at a first vent vertex and the second vent has a transverse cross-section profile shape defined by the second inner side and the second center side joined at a second vent vertex.

12. The buoyant pontoon of claim 11, wherein the first vent and the second vent have asymmetric transverse cross-sectional profile shapes.

13. The buoyant pontoon of claim 11, wherein the first vent comprises a first outer vent distance d1_{OV} defined by a vertical distance between the first low vertex and the first vent vertex and a first inner vent distance d1_{IV} defined by a vertical distance between the center low vertex and the first low vertex wherein the distance d1_{OV} is between about 40% and 90% of the distance d1_{IV}.

14. The buoyant pontoon of claim 11, wherein the second vent comprises a second outer vent distance d2_{OV} defined by a vertical distance between the second low vertex and the second vent vertex and a second inner vent distance d2_{IV} defined by a vertical distance between the center low vertex and the second low vertex, wherein the distance d2_{OV} is between about 40% and 90% of the distance d2_{IV}.

15. The buoyant pontoon of claim 10, wherein the first outer V-shaped feature comprises a distance d1_{OE} defined by a vertical distance between the outer edge of the first outer V-shaped feature and the first low vertex and a center V-shaped feature comprises a distance d1_{CV} defined by a vertical distance between the outer edge of the first outer V-shaped feature and the center low vertex, wherein the distance d1_{OE} is between 40% and 90% of the distance d1_{CV}.

16. The buoyant pontoon of claim 1, wherein the pontoon has a width w, and wherein the wherein the center V-shaped feature extends a vertical distance d lower than the first and second outer V-shaped features and the distance d is from about 0.5% to about 5% of the width w.

17. The buoyant pontoon of claim 1, wherein the first vent has a transverse cross-section profile shape in the form of an inverted V.

18. The buoyant pontoon of claim 1, wherein the second vent has a transverse cross-section profile shape in the form of an inverted V.

19. The buoyant pontoon of claim 1, further comprising an upper surface and a stern surface, wherein the upper surface is joined to the plumb bow, the first and second bow surfaces, the first and second lateral surfaces, and to the stern surface, and wherein the stern surface is further joined to the first and second lateral surfaces and to the bottom surface.

20. A pontoon boat comprising a pair of buoyant pontoons as claimed in claim 1.
